(19) United States
(12) Patent Application Publication
(10) Pub. No.: US 2026/0090677 A1
(43) Pub. Date: Apr. 2, 2026

(54) GRINDER WITH EASY-TO-REPLACE STORAGE CUP

(71) Applicant: NINGBO KAIDELI ELECTRIC CO., LTD, Ningbo (CN)

(72) Inventor: Songbiao Wang, Ningbo (CN)

(21) Appl. No.: 19/019,533

(22) Filed: Jan. 14, 2025

(30) Foreign Application Priority Data
Sep. 30, 2024 (CN) 202422412245.7

(51) Int. Cl. A47J 42/40

(52) U.S. Cl. CPC A47J 42/40

(57) ABSTRACT

A grinder with easy-to-replace storage cups includes a housing and at least two storage cups, where one end of the housing is provided with a mounting base fitting with a structure of the storage cup; the mounting base includes a bottom plate and an outer ring; a claw is provided at the bottom plate; a power unit connected to the claw is installed in the housing; a grinding component is provided in the storage cup; a snap ring fitting with the claw is formed in a surface of the storage cup; and the snap ring is connected to the grinding component. When the storage cup is inserted into the mounting base, the claw is embedded into the snap ring; the power unit works to drive the claw to rotate, so as to drive the snap ring to rotate; and the rotating snap ring drives the grinding component to work.

### CROSS REFERENCE TO RELATED APPLICATIONS

The present application claims the benefit of Chinese Patent Application No. 202422412245.7 filed on Sep. 30, 2024, the contents of which are incorporated herein by reference in their entirety.

### TECHNICAL FIELD

This application relates to the technical field of grinders, and in particular to, a grinder with easy-to-replace storage cups.

### BACKGROUND

At present, processed pepper, salt and pepper powders, and the like available on the market have significant differences in flavor compared to freshly ground seasonings. Therefore, more and more consumers are opting to use pepper grinders. Intact pepper corns are purchased and ground in a grinder to obtain natural and fresh pepper powder, salt and pepper powder, and the like.

Existing electric grinders come in various forms, allowing the consumers to choose suitable ones according to their actual needs. A grinder at present generally includes a housing, a storage cup, cells and a driving device, where the housing is in butt connection with the storage cup. In the existing grinder, the storage cup is primarily snap-fitted with the housing, specifically via a rotary snap-fit method. However, this installation way requires a large rotating force to snap-fit the storage cup and the housing together. Moreover, the rotating way is relatively cumbersome. Therefore, it is inconvenient to dismount and mount the storage cup and the housing.

### SUMMARY

In order to solve the technical problems, this application provides a grinder with easy-to-replace storage cups, where a connected structure between a storage cup and a housing is optimized, and multiple storage cups are equipped, which is convenient for a user to grind different granules.

A technical solution used in this application is as follows: a grinder with easy-to-replace storage cups, including a housing and at least two storage cups, where one end of the housing is provided with a mounting base fitting with a structure of the storage cup; the mounting base includes a bottom plate and an outer ring; a claw is provided at the bottom plate; a power unit connected to the claw is installed in the housing; a grinding component is provided in the storage cup; a snap ring fitting with the claw is formed in a surface of the storage cup; and the snap ring is connected to the grinding component, where when the storage cup is inserted into the mounting base, the claw is embedded into the snap ring; the power unit works to drive the claw to rotate, so as to drive the snap ring to rotate; and the rotating snap ring drives the grinding component to work.

Compared with the prior art, this application has the advantages that at least two storage cups are equipped in this application, and therefore the user can put different granules to be ground into different storage cups during use. The storage cup in this application may also be used as a storage cup for storing granules, which is more convenient for the user to use. That is, when grinding is not needed, the granules are placed in the storage cup, and the storage cup and the housing are stored separately. However, when granules need to be used, the storage cup containing the granules is installed into the mounting base, and the power unit is started to grind out powders. After grinding, when no further use is needed, the storage cup can be dismounted from the housing for separate storage. Specifically, in this application, the housing is provided with the mounting base, the mounting base includes a bottom plate and an outer ring, and the storage cup is wrapped by the outer ring, so that the storage cup is stable and reliable after installed. The claw connected to the power unit and the snap ring connected to the grinding component are provided, and when the storage cup is inserted into the mounting base, the claw is embedded into the snap ring, thereby achieving the power transmission of an entire structure. In this application, the storage cup is inserted into the housing, which is convenient for a user to mount and dismount them, is convenient for use with multiple storage cups, and is convenient for the user to grind different granules.

In some embodiments of this application, the bottom plate is further provided with a self-locking device; a mounting disc is provided on the surface of the storage cup in a protruding manner; and a circle of convex edge is provided on a periphery of the mounting disc. When the storage cup is inserted into the mounting base, the self-locking device locks the mounting disc.

Specifically, the self-locking device is a push-type self-locking spring clip; when the storage cup is inserted into the mounting base, the self-locking device is pushed by an applied force, and in this case, the self-locking device clamps and locks the mounting disc; and when it is necessary to dismount the storage cup, the storage cup is pushed inwards, so that the self-locking device is pushed by the storage cup, and in this case, the self-locking device unlocks to release the mounting disc.

In this application, the self-locking device used is directly purchased, and specifically may be a HeYing-brand DL-5 plastic door latch switch. Locking by push can be realized as well as unlocking by push again. With the insertion and extraction of the storage cup in this application, the storage cup can be mounted and dismounted simply and quickly.

In some embodiments of this application, the storage cup includes a cup body and a cup lid, one end of the cup body is open to form a feeding port, and the grinding component is installed on the other end of the cup body; a discharge port for exporting granules is provided in the grinding component; and the cup lid is snapped-fitted onto the cup body to cover the feeding port.

In this application, the cup body and the cup lid are connected to form a cavity for storing granules. When granules to be ground need to be stored, the cup lid is dismounted, and the feeding port is opened, then the granules to be ground can be poured. Then, the cup lid is installed and the feeding port is sealed, and the granules that have not been ground cannot be exported from the discharge port. In this way, the granules to be ground are stored in the storage cup very well.

In some embodiments of this application, the mounting disc is provided on a surface of the cup lid, the snap ring is provided in a center of the mounting disc, and the snap ring penetrates through the mounting disc. In this way, the structure of the storage cup is properly designed, thereby realizing the storage function of the storage cup, the export function of ground granules, and the detachable connection between the storage cup and the housing.

In some embodiments of this application, a transverse basal plane of the claw is of a herringbone structure; a groove is provided in one side face of the snap ring; multiple baffles are provided in a wall surface of the groove; and the claw extends into the groove and is connected to the baffles in a contact manner.

In some embodiments of this application, a snap groove is provided in the other side face of the snap ring; the grinding component is connected to a shaft piece; the shaft piece is inserted into the snap groove; and the groove and the snap groove are located on a central axis of the snap ring.

In some embodiments of this application, an outer surface of the cup body is ladder-shaped; one end of the cup body close to the cup lid is referred to as a top; the other end of the cup body away from the cup lid is referred to as a bottom; an outer diameter of the top of the cup body is less than that of the bottom of the cup body; the outer ring fits with a structure of the top of the cup body; and an outer diameter of the bottom of the cup body is greater than an aperture of the outer ring. That is, the structure of the cup body gives a limit position for the installation of the cup body and the housing, thereby avoiding that parts are damaged due to excessive insertion of the cup body.

In some embodiments of this application, multiple insertion strips provided in a protruding manner are provided on an outer surface of the top of the cup body; multiple convex strips are arranged regularly on an inner wall surface of the outer ring; a distance fitting with a structure of the insertion strip is reserved between two adjacent convex strips; and when the storage cup is inserted into the mounting base, the insertion strip is inserted into the convex strip. By providing a structure of insertion strips and convex strips, the storage cup is stable after installed without circumferential rotation.

In some embodiments of this application, a dry cell or a rechargeable storage battery is installed in the housing, and the dry cell or the storage battery supplies power to the power unit. In this application, a rechargeable grinder main body and a grinder main body depending on cells or batteries are designed. These two grinder main bodies are basically the same in structure, except for internal cells or batteries for power supply. The users can choose the suitable ones according to their actual needs.

In some embodiments of this application, the mounting base is made of a transparent material; a lighting lamp electrically connected to a control circuit board is provided in the housing; the lighting lamp is provided close to the mounting base; the cup body of the storage cup is made of a transparent material; and when the lighting lamp works, its light rays illuminate the mounting base and the storage cup. In this application, the lighting lamp plays a role of illumination and ambient lighting.

The above-mentioned implementations may be combined in any way based on the common knowledge in the art.

### BRIEF DESCRIPTION OF THE DRAWINGS

This application is described in further detail below in conjunction with the drawings and preferred embodiments, but those skilled in the art will understand that these drawings are drawn only for the purpose of illustrating the preferred embodiments and should not be used as a limitation on the scope of this application. In addition, unless specifically indicated, the drawings only illustrate conceptually the composition or construction of the described object and may contain exaggerated displays, and the drawings are not necessarily drawn to scale.

FIG. 1 is a schematic structural diagram of an unassembled state of this application;

FIG. 2 is a schematic structural diagram of an assembled state of this application;

FIG. 3 is a cross-sectional view of FIG. 2;

FIG. 4 is a schematic structural diagram of a housing in this application; and

FIG. 5 is a cross-sectional view of a housing in this application.

Reference numerals: 1, housing; 2, storage cup; 3, mounting base; 4, bottom plate; 5, outer ring; 6, claw; 7, power unit; 8, grinding component; 9, snap ring; 91, baffle; 92, snap groove; 10, cup body; 11, cup lid; 12, discharge port; 13, mounting disc; 14, self-locking device; 15, dry cell; 16, storage battery; 17, shaft piece; 18, insertion strip; 19, convex strip; and 20, lighting lamp.

### DETAILED DESCRIPTION

This application is described in detail below in conjunction with the drawings.

In order to make the objects, technical solutions and advantages of this application more clearly understood, this application is further described in detail below in conjunction with the drawings and the embodiments. It should be understood that the specific embodiments described here are only intended to explain this application and are not intended to limit this application.

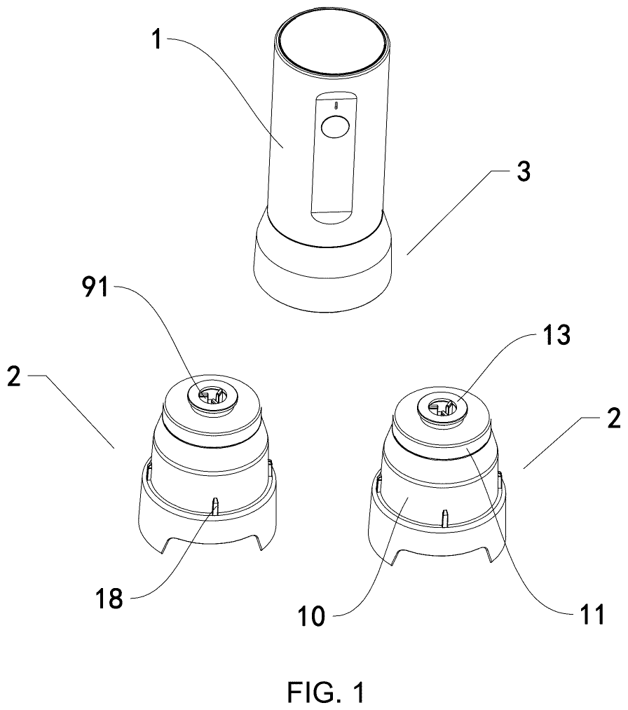

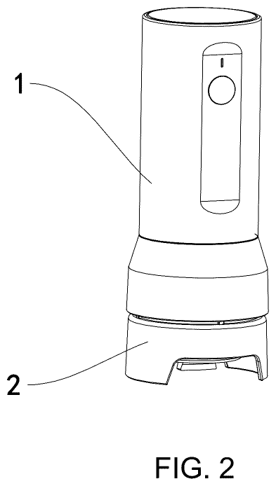

In embodiment I, as shown in FIG. 1 to FIG. 3, a grinder with easy-to-replace storage cups includes: a housing 1 and at least two storage cups 2, where one end of the housing 1 is provided with a mounting base 3 fitting with a structure of the storage cup 2. In this application, the storage cup 1 is inserted into the housing 2, which is convenient for a user to mount and dismount them, is convenient for use with multiple storage cups, and is convenient for the user to grind different granules.

The mounting base 3 includes a bottom plate 4 and an outer ring 5. A claw 6 is provided at the bottom plate 4. A power unit 7 connected to the claw 6 is installed in the housing. A grinding component 8 is provided in the storage cup 2. A snap ring 9 fitting with the claw 6 is formed in a surface of the storage cup 2. The snap ring 9 is connected to the grinding component 8. When the storage cup 2 is inserted into the mounting base 3, the claw 6 is embedded into the snap ring 9. The power unit 7 works to drive the claw 6 to rotate, so as to drive the snap ring 9 to rotate. The rotating snap ring 9 drives the grinding component 8 to work. The storage cup 2 is wrapped by the outer ring 5, so that the storage cup 2 is stable and reliable after installed. The claw 6 connected to the power unit 7 and the snap ring 9 connected to the grinding component 8 are provided, and when the storage cup 2 is inserted into the mounting base 3, the claw 6 is embedded into the snap ring 9, thereby achieving the power transmission of an entire structure.

At least two storage cups 2 are equipped in this application, and therefore the user can put different granules to be ground into different storage cups 2 during use. The storage cup 2 in this application may also be used as a storage cup for storing granules, which is more convenient for the user to use. That is, when grinding is not needed, the granules are placed in the storage cup 2, and the storage cup 2 and the housing 1 are stored separately. However, when granules need to be used, the storage cup 2 containing the granules is installed into the mounting base 3, and the power unit 7 is started to grind out powders. After grinding, when no further use is needed, the storage cup 2 can be dismounted from the housing for separate storage.

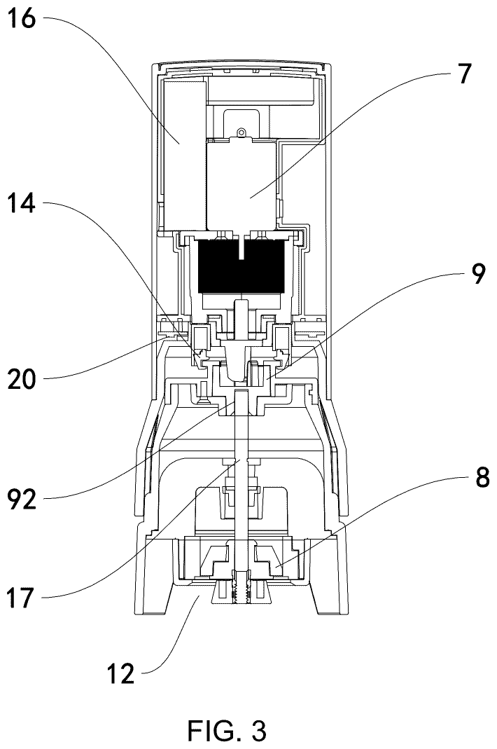

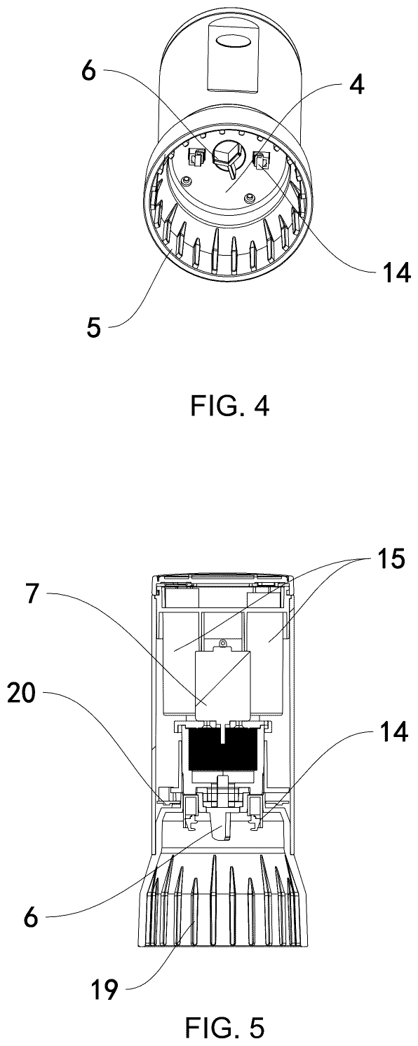

In embodiment II, as shown in FIG. 3 to FIG. 5, the storage cup 2 includes a cup body 10 and a cup lid 11, one end of the cup body 10 is open to form a feeding port, and the grinding component 8 is installed on the other end of the cup body 10. A discharge port 12 for exporting granules is provided in the grinding component 8. The cup lid 11 is snapped-fitted onto the cup body 10 to cover the feeding port.

In this application, the cup body 10 and the cup lid 11 are connected to form a cavity for storing granules. When granules to be ground need to be stored, the cup lid 11 is dismounted, and the feeding port is opened, then the granules to be ground can be poured. Then, the cup lid 11 is installed and the feeding port is sealed, and the granules that have not been ground cannot be exported from the discharge port 12. In this way, the granules to be ground are stored in the storage cup 2 very well.

The mounting disc 13 is provided on a surface of the cup lid 11, the snap ring 9 is provided in a center of the mounting disc 13, and the snap ring 9 penetrates through the mounting disc 13. In this way, the structure of the storage cup 2 is properly designed, thereby realizing the storage function of the storage cup 2, the export function of ground granules, and the detachable connection between the storage cup 2 and the housing 1.

A transverse basal plane of the claw 6 is of a herringbone structure. A groove is provided in one side face of the snap ring 9. Multiple baffles 91 are provided in a wall surface of the groove. The claw 6 extends into the groove and is connected to the baffles 91 in a contact manner.

A snap groove 92 is provided in the other side face of the snap ring 9. The grinding component 8 is connected to a shaft piece 17. The shaft piece 17 is inserted into the snap groove 92. The groove and the snap groove 92 are located on a central axis of the snap ring 9.

An outer surface of the cup body 10 is ladder-shaped. One end of the cup body 10 close to the cup lid 11 is referred to as a top. The other end of the cup body 10 away from the cup lid 11 is referred to as a bottom. An outer diameter of the top of the cup body 10 is less than that of the bottom of the cup body 10. The outer ring 5 fits with a structure of the top of the cup body 10. An outer diameter of the bottom of the cup body 10 is greater than an aperture of the outer ring 5. That is, the structure of the cup body 10 gives a limit position for the installation of the cup body 10 and the housing 1, thereby avoiding that parts are damaged due to excessive insertion of the cup body 10.

Multiple insertion strips 18 provided in a protruding manner are provided on an outer surface of the top of the cup body 10. Multiple convex strips 19 are arranged regularly on an inner wall surface of the outer ring 5. A distance fitting with a structure of the insertion strip 18 is reserved between two adjacent convex strips 19. When the storage cup 2 is inserted into the mounting base 3, the insertion strip 18 is inserted into the convex strip 19. By providing a structure of insertion strips 18 and convex strips 19, the storage cup 2 is stable after installed without circumferential rotation.

Other contents of embodiment II are the same as those of embodiment I.

In embodiment III, as shown in FIG. 1 to FIG. 3, the bottom plate 4 is further provided with a self-locking device 14. A mounting disc 13 is provided on the surface of the storage cup 2 in a protruding manner. A circle of convex edge is provided on a periphery of the mounting disc 13. When the storage cup 2 is inserted into the mounting base 3, the self-locking device 14 locks the mounting disc 13.

Specifically, the self-locking device 14 is a push-type self-locking spring clip. When the storage cup 2 is inserted into the mounting base 3, the self-locking device 14 is pushed by an applied force, and in this case, the self-locking device 14 clamps and locks the mounting disc 13. When it is necessary to dismount the storage cup 2, the storage cup 2 is pushed inwards, so that the self-locking device 14 is pushed by the storage cup 2, and in this case, the self-locking device 14 unlocks to release the mounting disc 13.

In this application, the self-locking device 14 used is directly purchased, and specifically may be a HeYing-brand DL-5 plastic door latch switch. Locking by push can be realized as well as unlocking by push again. With the insertion and extraction of the storage cup 2 in this application, the storage cup 2 can be mounted and dismounted simply and quickly.

As shown in FIG. 3 and FIG. 5, a dry cell 15 or a rechargeable storage battery 16 is installed in the housing 1, and the dry cell 15 or the storage battery 16 supplies power to the power unit 7. In this application, a rechargeable grinder main body and a grinder main body depending on cells or batteries are designed. These two grinder main bodies are basically the same in structure, except for internal cells or batteries for power supply. The users can choose the suitable ones according to their actual needs.

The mounting base 3 is made of a transparent material. A lighting lamp 20 electrically connected to a control circuit board is provided in the housing 1. The lighting lamp 20 is provided close to the mounting base 3. The cup body 10 of the storage cup 2 is made of a transparent material. When the lighting lamp 20 works, its light rays illuminate the mounting base 3 and the storage cup 2. In this application, the lighting lamp 20 plays a role of illumination and ambient lighting.

Other contents of embodiment III are the same as those of embodiment I or embodiment II.

This application is introduced in detail above. The principles and implementations of this application are described using specific examples herein, the descriptions of the foregoing embodiments are merely intended to help understand this application and the core idea. It should be noted that those of ordinary skilled in the art can also make several improvements and modifications to this application without departing from the principles of this application, and these improvements and modifications also fall within the scope of protection of the claims in this application.

What is claimed is:

1. A grinder with easy-to-replace storage cups, comprising a housing (1) and at least two storage cups (2), wherein one end of the housing (1) is provided with a mounting base (3) fitting with a structure of each storage cup (2); the mounting base (3) comprises a bottom plate (4) and an outer ring (5); a claw (6) is provided at the bottom plate (4); a power unit (7) connected to the claw (6) is installed in the housing (1); a grinding component (8) is provided in the storage cup (2); a snap ring (9) fitting with the claw (6) is formed in a surface of the storage cup (2); and the snap ring (9) is connected to the grinding component (8), wherein when the storage cup (2) is inserted into the mounting base (3), the claw (6) is embedded into the snap ring (9); the power unit (7) works to drive the claw (6) to rotate, so as to drive the snap ring (9) to rotate; and rotation of the snap ring (9) drives the grinding component (8) to work.

2. The grinder with easy-to-replace storage cups (2) according to claim 1, wherein the bottom plate (4) is further provided with a self-locking device (14); a mounting disc (13) is provided on the surface of the storage cup (2) in a protruding manner; and a circle of convex edge is provided on a periphery of the mounting disc (13), wherein when the storage cup (2) is inserted into the mounting base (3), the self-locking device (14) locks the mounting disc (13).

3. The grinder with easy-to-replace storage cups (2) according to claim 2, wherein the self-locking device (14) is a push-type self-locking spring clip; when the storage cup (2) is inserted into the mounting base (3), the self-locking device (14) is pushed by an applied force, and in this case, the self-locking device (14) clamps and locks the mounting disc (13); and when it is necessary to dismount the storage cup (2), the storage cup (2) is pushed inwards, so that the self-locking device (14) is pushed by the storage cup (2), and in this case, the self-locking device (14) unlocks to release the mounting disc (13).

4. The grinder with easy-to-replace storage cups (2) according to claim 3, wherein the storage cup (2) comprises a cup body (10) and a cup lid (11), one end of the cup body (10) is open to form a feeding port, and the grinding component (8) is installed on an other end of the cup body (10); a discharge port (12) for exporting granules is provided in the grinding component (8); and the cup lid (11) is snapped-fitted onto the cup body (10) to cover the feeding port.

5. The grinder with easy-to-replace storage cups (2) according to claim 4, wherein the mounting disc (13) is provided on a surface of the cup lid (11), the snap ring (9) is provided in a center of the mounting disc (13), and the snap ring (9) penetrates through the mounting disc (13).

6. The grinder with easy-to-replace storage cups (2) according to claim 4, wherein the mounting base (3) is made of a transparent material; a lighting lamp (20) electrically connected to a control circuit board is provided in the housing (1); the lighting lamp (20) is provided close to the mounting base (3); the cup body (10) of the storage cup (2) is made of a transparent material; and when the lighting lamp (20) works, its light rays illuminate the mounting base (3) and the storage cup (2).

7. The grinder with easy-to-replace storage cups (2) according to claim 1, wherein a transverse basal plane of the claw (6) is of a herringbone structure; a groove is provided in one side face of the snap ring (9); a plurality of baffles (91) are provided in a wall surface of the groove; the claw (6) extends into the groove and is connected to the baffles (91) in a contact manner; a snap groove (92) is provided in an other side face of the snap ring (9); the grinding component (8) is connected to a shaft piece (17); the shaft piece (17) is inserted into the snap groove (92); and the groove and the snap groove (92) are located on a central axis of the snap ring (9).

8. The grinder with easy-to-replace storage cups (2) according to claim 4, wherein an outer surface of the cup body (10) is ladder-shaped; one end of the cup body (10) close to the cup lid (11) is referred to as a top; an other end of the cup body (10) away from the cup lid (11) is referred to as a bottom; an outer diameter of the top of the cup body (10) is less than that of the bottom of the cup body (10); the outer ring (5) fits with a structure of the top of the cup body (10); and an outer diameter of the bottom of the cup body (10) is greater than an aperture of the outer ring (5).

9. The grinder with easy-to-replace storage cups (2) according to claim 8, wherein a plurality of insertion strips (18) provided in a protruding manner are provided on an outer surface of the top of the cup body (10); a plurality of convex strips (19) are arranged regularly on an inner wall surface of the outer ring (5); a distance fitting with a structure of the insertion strips (18) is reserved between two adjacent convex strips (19); and when the storage cup (2) is inserted into the mounting base (3), the insertion strips (18) are inserted into the convex strips (19).

10. The grinder with easy-to-replace storage cups (2) according to claim 1, wherein a dry cell (15) or a rechargeable storage battery (16) is installed in the housing (1), and the dry cell (15) or the storage battery (16) supplies power to the power unit (7).
